(19) United States
(12) Patent Application Publication
(10) Pub. No.: US 2021/0024196 A1
(43) Pub. Date: Jan. 28, 2021

(54) AIRCRAFT, INTERIOR PANELS FOR AIRCFRAFT, AND METHODS FOR MAKING INTERIOR PANELS

(71) Applicant: Gulfstream Aerospace Corporation, Savannah, GA (US)

(72) Inventors: Kevin Sethapun, Savannah, GA (US); Katherine Young, Savannah, GA (US)

(73) Assignee: Gulfstream Aerospace Corporation, Savannah, GA (US)

(21) Appl. No.: 16/522,393

(22) Filed: Jul. 25, 2019

(51) Int. Cl. B64C 1/06; B60R 13/02; B64D 47/02

(52) U.S. Cl. CPC B64C 1/066; B64D 47/02; B60R 13/0206

(57) ABSTRACT

An interior panel for an aircraft, an aircraft including an interior panel, and a method for making an interior panel for an aircraft are provided. In one example, the interior panel includes a support substrate that has a substrate surface. A first trim section is coupled to the support substrate. The first trim section has a first exposed surface that extends to a first edge portion. A second trim section is coupled to the support substrate. The second trim section has a second exposed surface that extends to a second edge portion that is disposed adjacent to the first edge portion. The first edge portion is offset from the second edge portion to define a gap. A light source is substantially covered by the first exposed surface and generates light that passes through the gap and illuminates at least a portion of the second exposed surface.

### TECHNICAL FIELD

The technical field relates generally to interiors for aircraft, and more particularly, relates to interior panels for aircraft such as, for example, bulkheads or the like, and methods for making such interior panels.

### BACKGROUND

Aircraft typically include interior panels to cover the aircraft structure and/or to act as a visual and/or physical partition for dividing an aircraft interior into distinct, separated, and/or partially separated sections. In one example, one or more interior panels form at least part of a bulkhead structure that separates a cabin area that includes seating from the galley and/or the lavatory area(s). Interior panels may also be used, for example, to separate seating classes such as first class, economy class, and/or business class.

Because interior panels are highly visible structures, it is desirable that interior panels have an aesthetically pleasing appearance and/or design. Additionally, it is desirable to provide interior panels that have functionality for aircraft passengers given that the interior panels are commonly disposed near and/or around passenger seating and/or passenger amenities such as lavatory areas. For example, bulkheads are ideally situated to serve as a location to mount a light source(s). Bulkheads are oriented perpendicular to their respective internal compartments and have often served as a location for supporting lights and/or sconces. Unfortunately, the protrusion of lights and/or sconces from the surface of a bulkhead or other interior structure can be unsightly and/or obtrusive.

Accordingly, it is desirable to provide an interior panel for an aircraft that addresses one or more of the foregoing issues, an aircraft including such an interior panel, and a method for making such an interior panel. Furthermore, other desirable features and characteristics of the various embodiments described herein will become apparent from the subsequent detailed description and the appended claims, taken in conjunction with the accompanying drawings and this background.

### SUMMARY

Various non-limiting embodiments of an interior panel for an aircraft, an aircraft, and a method for making an interior panel for an aircraft, are provided herein.

In a first non-limiting embodiment, the interior panel includes, but is not limited to, a support substrate that has a substrate surface that faces generally in a first direction. The interior panel further includes, but is not limited to, a first trim section that is coupled to the support substrate and is disposed adjacent to the substrate surface. The first trim section has a first exposed surface that extends to a first edge portion. The interior panel further includes, but is not limited to, a second trim section that is coupled to the support substrate and is disposed adjacent to the substrate surface. The second trim section has a second exposed surface that extends to a second edge portion that is disposed adjacent to the first edge portion. The first edge portion is offset from the second edge portion in the first direction to define a gap therebetween. The interior panel further includes, but is not limited to, a light source that is substantially covered by the first exposed surface and is configured to generate light that passes through the gap and illuminates at least a portion of the second exposed surface.

In another non-limiting embodiment, the aircraft includes, but is not limited to, an aircraft structure that has an interior. The aircraft further includes, but is not limited to, an interior panel that is disposed in the interior of the aircraft structure. The interior panel includes, but is not limited to, a support substrate that has a substrate surface that faces generally in a first direction. The interior panel further includes, but is not limited to, a first trim section that is coupled to the support substrate and is disposed adjacent to the substrate surface. The first trim section has a first exposed surface that extends to a first edge portion. The interior panel further includes, but is not limited to, a second trim section that is coupled to the support substrate and is disposed adjacent to the substrate surface. The second trim section has a second exposed surface that extends to a second edge portion that is disposed adjacent to the first edge portion. The first edge portion is offset from the second edge portion in the first direction to define a gap therebetween. The interior panel further includes, but is not limited to, a light source that is substantially covered by the first exposed surface and is configured to generate light that passes through the gap and illuminates at least a portion of the second exposed surface.

In another non-limiting embodiment, the method includes, but is not limited to, obtaining a support substrate that has a substrate surface that is configured to face generally in a first direction. The method further includes, but is not limited to, coupling a first trim section to the support substrate such that the first trim section is disposed adjacent to the substrate surface. The first trim section has a first exposed surface that extends to a first edge portion. The method further includes, but is not limited to, coupling a second trim section to the support substrate such that the second trim section is disposed adjacent to the substrate surface. The second trim section has a second exposed surface that extends to a second edge portion that is disposed adjacent to the first edge portion. The first edge portion is offset from the second edge portion in the first direction to define a gap therebetween. The method further includes, but is not limited to, substantially covering a light source with the first exposed surface. The light source is configured to generate light that passes through the gap and illuminates at least a portion of the second exposed surface.

### BRIEF DESCRIPTION OF THE DRAWINGS

The various embodiments will hereinafter be described in conjunction with the following drawing figures, wherein like numerals denote like elements, and wherein:

FIG. 1 illustrates a front view of an interior panel arranged in an interior of an aircraft in accordance with an exemplary embodiment;

FIG. 2 illustrates a cross-sectional view of the interior panel depicted in FIG. 1 along line 2-2; and

FIG. 3 illustrates a method for making an interior panel in accordance with an exemplary embodiment.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

Various embodiments contemplated herein relate to interior panels for an aircraft, aircraft including an interior panel, and methods for making an interior panel for an aircraft. The exemplary embodiments taught herein provide an interior panel for an aircraft in which the interior panel includes a support substrate that has a substrate surface facing generally in a first direction. A first trim section is coupled to the support substrate and is disposed adjacent to the substrate surface. The first trim section has a first exposed surface that extends to a first edge portion. A second trim section is coupled to the support substrate and is disposed adjacent to the substrate surface. The second trim section has a second exposed surface that extends to a second edge portion that is disposed adjacent to the first edge portion. The first edge portion is offset from the second edge portion in the first direction to define a gap. A light source is substantially covered by the first exposed surface. When the light source is turned on or is otherwise operating, it generates light that passes through the gap and illuminates at least a portion of the second exposed surface to provide light to the interior of the aircraft.

In an exemplary embodiment, the first exposed surface and the second exposed surface are each independently contoured and/or decorated surfaces that are visible, for example, to passengers or other occupants in the aircraft. Additionally, by substantially covering the light source with the first exposed surface, the light source(s) does not protrude from the first exposed surface and thus is hidden, for example, to passengers or other occupants in the aircraft. As such, the light source(s) is neither unsightly nor obtrusive. Advantageously, in an exemplary embodiment, by incorporating the light source(s) into the interior panel such that the light source(s) is hidden and by presenting the interior panel with contoured and/or decorated exposed surfaces that are highly visible, an aesthetically pleasing decorative interior panel that also provides the functionality of aircraft interior lighting is provided.

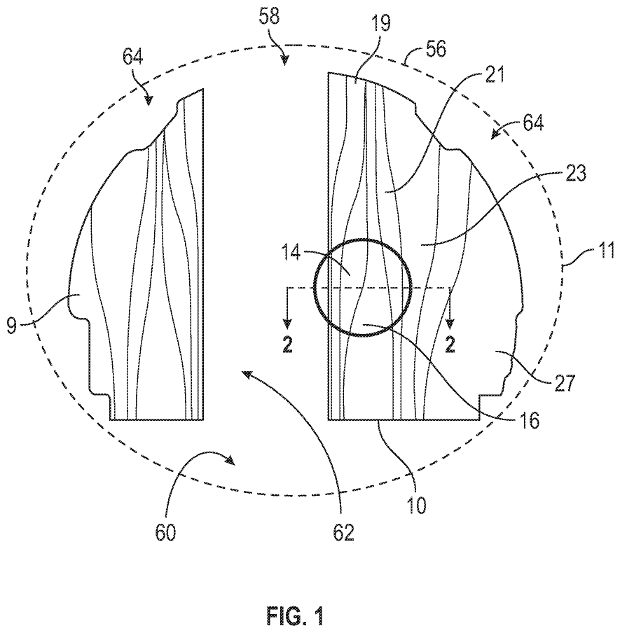

FIG. 1 illustrates a front view of spaced apart interior panels 9 and 10 that are arranged in an aircraft 11 in accordance with an exemplary embodiment. Although the aircraft 11 is illustrated as having two interior panels 9 and 10, it is to be understood that the aircraft 11 may have a single interior panel or more than two interior panels. The aircraft 11 includes an aircraft structure 56 (e.g., fuselage or the like) that has an interior 58. As illustrated, the interior panels 9 and 10 are disposed in the interior 58 of the aircraft structure 56. In an exemplary embodiment, the interior 58 of the aircraft 11 includes two adjacent interior areas 60 and 62 and the interior panels 9 and 10 each forms at least part of a bulkhead 64 that at least partially separates the two interior areas 60 and 62 from each other. As illustrated, the interior panel 9 and 10 are spaced apart to form a passage to allow passengers and/or other occupants to pass between the interior areas 60 and 62.

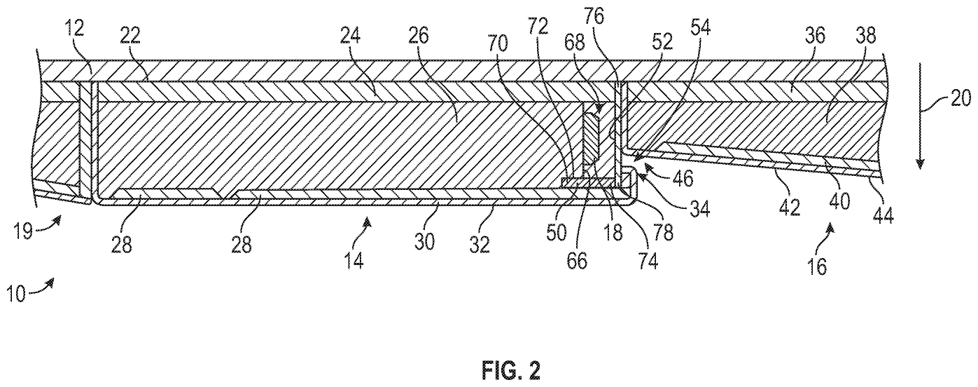

Referring also to FIG. 2, a cross-sectional view of the interior panel 10 depicted in FIG. 1 along ling 2-2 is provided. As illustrated, the interior panel 10 includes a support substrate 12, a plurality of trim sections 14, 16, 19, 21, 23, 25, and 27 including adjacent trim sections 14 and 16, and a light source 18. Although the interior panel 10 is illustrated as having a plurality of trim sections 14, 16, 19, 21, 23, 25, and 27, it is to be understood that the interior panel 10 can have fewer trim sections than depicted but at least two adjacent trim sections, or more trim sections than depicted.

The support substrate 12 is an underlying support structure (e.g., underlying support wall) for the interior panel 10. In an exemplary embodiment, the support substrate 12 is a honeycomb structure that is made of aluminum or aramid fibers such as, for example, Nomex® or Kevlar®.

As illustrated, the support substrate 12 has a substrate surface 22 and the support substrate 12 is arranged in the aircraft interior 58 such that the substrate surface 22 faces generally in a direction (indicated by single-headed arrow 20). For example, the direction 20 relative to the orientation of the aircraft 11 may be a rearward direction in which passenger or other occupants who are disposed rearward of the interior panel 10 can view the interior panel 10 by looking in a forward direction towards the front of the aircraft 11. Alternatively, the direction 20 relative to the orientation of the aircraft 11 may be a forward direction in which passenger or other occupants who are disposed forward of the interior panel 10 can view the interior panel 10 by looking in a rearward direction towards the rear of the aircraft 11.

The trim sections 14, 16, 19, 21, 23, 25, and 27 are each independently affixed, attached, or otherwise directly or indirectly coupled to the support substrate 12 adjacent to the substrate surface 22. For example, the trim sections 14, 16, 19, 21, 23, 25, and 27 may be coupled to the support substrate 12 via an insert(s), a threaded fastener(s), adhesive(s), a mechanical interlocking arrangement (e.g., snap fit, etc.), or the like.

As illustrated, the adjacent trim sections 14 and 16 each include a trim substrate 24, 36 that is disposed adjacent to the substrate surface 22 and supported by the support substrate 12. In an exemplary embodiment, the trim substrates 24 and 36 are each a honeycomb structure that is made of aluminum or aramid fibers such as, for example, Nomex® or Kevlar®. In an exemplary embodiment, the trim substrates 24 and 36 protrude or otherwise extend from the support substrate 12 in the direction 20.

In an exemplary embodiment, the trim sections 14 and 16 each include a filler 26, 38. The filler 26 is disposed adjacent to the trim substrate 24 for example, between the trim substrate 24 and an outer covering 30 as will be discussed in further detail below. In an exemplary embodiment, the filler 26 protrudes or otherwise extends from the trim substrate 24 in the direction 20. Likewise, the filler 38 is disposed adjacent to the trim substrate 36 for example, between the trim substrate 36 and an outer covering 42 as will be discussed in further detail below. In an exemplary embodiment, the filler 38 protrudes or otherwise extends from the trim substrate 36 in the direction 20. In an exemplary embodiment the fillers 26 and 38 are each formed of a foam, such as a relatively rigid or hard foam that is dimensionally stable and/or resistant to compression set, for example a closed cell polyurethane or polyolefin foam, or the like.

In an exemplary embodiment, the trim sections 14 and 16 each include an additional filler 28, 40 that is disposed adjacent to the filler 26, 38. In an exemplary embodiment, the additional fillers 28 and 40 are relatively soft foam layers that provide a pleasingly tactile feel, for example an open cell polyurethane or polyolefin foam, or the like.

As illustrated and as briefly discussed above, the trim sections 14 and 16 include the outer coverings 30 and 42. The outer coverings 30 and 42 may each independently be formed of a cover skin, such as a textile skin, a polyvinyl chloride (PVC) skin, a thermoplastic polyurethane (TPU) skin, a thermoplastic polyolefin (TPO) skin, or other covering material that may be decorated. Alternatively, the outer coverings 30 and 42 may each independently be formed of a bi-laminate or trilaminate material, that includes the cover skin and, for example, the additional filler(s) 28, 40 as discussed above.

The outer covering 30 substantially covers the remaining portions of the trim section 14 and includes an outer or exposed surface 32 that extends to an edge portion 34. That is, for example, the support substrate 12, the trim substrate 24, the filler 26, and the filler 28 of the trim section 14 underlie the outer covering 30. As used herein, the term “underlie” or “underlying” means “under” or “beneath” such that, for example, the underlying article is at least partially covered by the article mentioned directly after the term “underlying.” As such, the exposed surface 32 is spaced apart from the support substrate 12 in the direction 20.

Likewise, the outer covering 42 substantially covers the remaining portions of the trim section 16 and includes an outer or exposed surface 44 that extends to an edge portion 46. That is, for example, the support substrate 12, the trim substrate 36, the filler 38, and the filler 40 underlie the outer covering 42. As such, the exposed surface 44 is spaced apart from the support substrate 12 in the direction 20.

In an exemplary embodiment and as illustrated, the edge portion 34 of the trim section 14 and the edge portion 46 of the trim section 16 are disposed adjacent to each other. As illustrated, the edge portion 34 is offset and proud of the edge portion 46 in the direction 20 to define a gap 54 between the edge portions 34 and 46. As indicated above, the interior panel 10 includes the light source 18, which is disposed adjacent to the gap 54 and substantially covered by the exposed surface 32 of the trim section 14. As used herein, the phrase “substantially covered” means that the underlying article that is “substantially covered” is hidden and/or not viewable by a passenger or other occupant of the aircraft 11 as the overlying article fully or nearly fully obstructs the view of the underlying article. When turned on or otherwise operating, the light source 18 generates light that passes through the gap 54 and illuminates at least the adjacent portion(s) of the exposed surface 44 of the trim section 16, providing localized lighting to the nearby area of the interior 58 of the aircraft 11. For example, the light source 18 illuminates a portion(s) of the exposed surface 44 such that from the perspective of a passenger or other occupant of the aircraft 11, the illuminated portion(s) of the exposed surface 44 looks like an illuminated strip or band that is disposed adjacent to the gap 54.

In an exemplary embodiment, the light source 18 is disposed in the trim section 14 underlying the exposed surface 32. Further, in an exemplary embodiment, the light source 18 is in a direct line of sight to the gap 54 and the gap 54 is obscured by the edge portion 34 of the trim section 14. In an exemplary embodiment, the light source 18 is disposed adjacent to and mounted on a sidewall 66 of the filler 26 and the sidewall 66 is substantially parallel to the direction 20 and that faces the gap 54 and the trim section 16. In particular and as illustrated, the light source 18 is disposed in a cavity 68 formed between the trim substrate 24, the sidewall 66 of the filler 26, and the outer covering 30. In an exemplary embodiment, the light source 18 is a light-emitting diode(s) (LED), an LED strip(s), or the like.

As illustrated, the trim section 14 includes a rigid support insert 50 underlying the outer covering 30. In an exemplary embodiment, the rigid support insert 50 has an end portion 70 that is disposed in a pocket 72 formed in a distal portion of the filler 26 adjacent to the sidewall 66 and that is sandwiched between the filler 26 and the outer covering 30 and optionally the additional filler 28 if present. The remaining portion 74 of the rigid support insert 50 is cantilevered, extending across the cavity 68 and adjacent to the light source 18 towards the edge portion 34 of the trim section 14. In an exemplary embodiment, the rigid support insert 50 provides localized rigidity or structure that promotes a well-defined, crisp, craftsmanship-like edge portion 34 and further, protects the light source 18 from being damaged, for example, by preventing or minimizing any intrusion into the cavity 68 towards the light source 18 resulting from an object or other force acting on the outer covering 30 proximate the edge portion 34. In an exemplary embodiment, the rigid support insert 50 is formed of metal, such as a stamped or punched sheet metal tab or the like. Alternatively, the rigid support insert 50 may be formed of a filled or rigid plastic or polymeric material, a composite material, or the like.

In an exemplary embodiment, the interior panel 10 includes a lens 52 that is disposed across and/or adjacent to the gap 54. As illustrated, the lens 52 covers the gap 54 and is adjacent to the cavity 68 and the light source 18 such that light that is generated from the light source 18 passes from the cavity 68 through the lens 52 towards the trim section 16. The lens 52 extends from the support substrate 12 to the filler 28 in the direction 20. In an exemplary embodiment, the lens 52 has a proximal end portion 76 that is sandwiched between the trim substrate 24 and the trim section 16. The lens 52 extends distally in the direction 20 from the proximal end portion 76 across the cavity 68 and the gap 54 to a distal end portion 78 that is sandwiched between the rigid support insert 50 and the edge portion 34 of the trim section 14. The lens 52 may be a frosted lens, a transparent lens, a translucent lens, or the like. In an exemplary embodiment, the lens 52 is a frosted lens that diffuses light generated by the light source 18 to provide a diffused, aesthetically pleasing effect such as, for example, a homogeneous illumination and/or a uniformly dispersed intensity of light on the exposed surface 44 of the trim section 16.

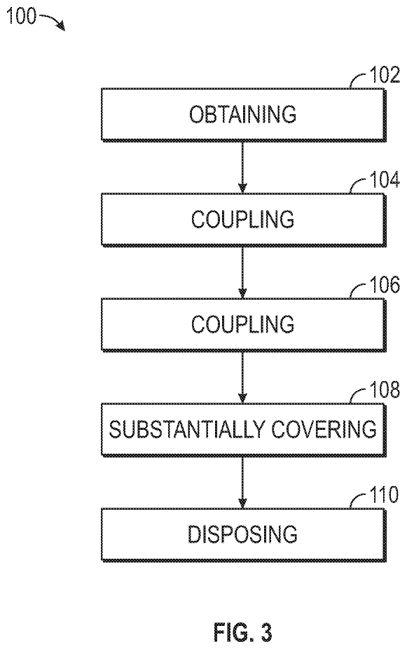

Referring to FIG. 3, a method 100 for making an interior panel for an aircraft in accordance with an exemplary embodiment is provided. The method 100 includes obtaining (STEP 102) a support substrate that has a substrate surface that is configured to face generally in a first direction. For example, the support substrate may be obtained by forming the support substrate, procuring the support substrate, and/or locating the support substrate.

A first trim section is coupled (STEP 104) to the support substrate such that the first trim section is disposed adjacent to the substrate surface. The first trim section has a first exposed surface that extends to a first edge portion. In an exemplary embodiment, coupling (STEP 104) the first trim section to the support substrate includes disposing the first exposed surface such that the first exposed surface is spaced apart from the support substrate in the first direction.

A second trim section is coupled (STEP 106) to the support substrate such that the second trim section is disposed adjacent to the substrate surface. The second trim section has a second exposed surface that extends to a second edge portion that is disposed adjacent to the first edge portion. The first edge portion is offset from the second edge portion in the first direction to define a gap therebetween. In an exemplary embodiment, coupling (STEP 106) the second trim section to the support substrate includes disposing the second exposed surface such that the second exposed surface is spaced apart from the support substrate in the first direction.

A light source is substantially covered (STEP 108) with the first exposed surface. The light source is configured to generate light that passes through the gap and illuminates at least a portion of the second exposed surface. In an exemplary embodiment, substantially covering (STEP 108) the light source with the first exposed surface includes disposing the light source in the first trim section underlying the first exposed surface. In an exemplary embodiment, the method includes disposing (STEP 110) a lens across and/or adjacent to the gap.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. An interior panel for an aircraft, the interior panel comprising:
a support substrate having a substrate surface that faces generally in a first direction;
a first trim section coupled to the support substrate and disposed adjacent to the substrate surface, the first trim section having a first exposed surface extending to a first edge portion;
a second trim section coupled to the support substrate and disposed adjacent to the substrate surface, the second trim section having a second exposed surface extending to a second edge portion that is disposed adjacent to the first edge portion, wherein the first edge portion is offset from the second edge portion in the first direction to define a gap therebetween; and
a light source substantially covered by the first exposed surface and configured to generate light that passes through the gap and illuminates at least a portion of the second exposed surface.

2. The interior panel of claim 1, wherein the first exposed surface and the second exposed surface are each independently spaced apart from the support substrate in the first direction.

3. The interior panel of claim 1, wherein the light source is disposed in the first trim section underlying the first exposed surface.

4. The interior panel of claim 1, wherein the light source includes a light-emitting diode (LED).

5. The interior panel of claim 1, further comprising a lens disposed one of across and adjacent to the gap.

6. The interior panel of claim 5, wherein the lens is configured as a frosted lens that diffuses the light.

7. The interior panel of claim 1, wherein the first trim section includes a first outer covering, and wherein the second trim section includes a second outer covering, and wherein the first outer covering includes the first exposed surface and the second outer covering includes the second exposed surface.

8. The interior panel of claim 7, wherein the first trim section further includes a first trim substrate that is coupled to the support substrate underlying the first outer covering, and wherein the second trim section further includes a second trim substrate that is coupled to the support substrate underlying the second outer covering.

9. The interior panel of claim 8, wherein the first trim section further includes a first filler that is disposed between the first trim substrate and the first outer covering, and wherein the second trim section further includes a second filler that is disposed between the second trim substrate and the second outer covering.

10. An aircraft comprising:
an aircraft structure having an interior; and
an interior panel disposed in the interior of the aircraft structure, the interior panel comprising:
a support substrate having a substrate surface that faces generally in a first direction;
a first trim section coupled to the support substrate and disposed adjacent to the substrate surface, the first trim section having a first exposed surface extending to a first edge portion;
a second trim section coupled to the support substrate and disposed adjacent to the substrate surface, the second trim section having a second exposed surface extending to a second edge portion that is disposed adjacent to the first edge portion, wherein the first edge portion is offset from the second edge portion in the first direction to define a gap therebetween; and
a light source substantially covered by the first exposed surface and configured to generate light that passes through the gap and illuminates at least a portion of the second exposed surface.

11. The aircraft of claim 10, wherein the interior of the aircraft structure includes a first interior area and a second interior area, and wherein the interior panel forms at least part of a bulkhead that at least partially separates the first interior area from the second interior area.

12. The aircraft of claim 10, wherein the interior panel further includes a lens disposed one of across and adjacent to the gap.

13. The aircraft of claim 12, wherein the light source is disposed in the first trim section adjacent to the lens and underlying the first exposed surface.

14. The aircraft of claim 13, wherein the first trim section includes a first outer covering, and wherein the second trim section includes a second outer covering, and wherein the first outer covering includes the first exposed surface and the second outer covering includes the second exposed surface.

15. The aircraft of claim 14, wherein the first trim section further includes a first trim substrate that is coupled to the support substrate underlying the first outer covering, and wherein the second trim section further includes a second trim substrate that is coupled to the support substrate underlying the second outer covering.

16. The aircraft of claim 15, wherein the first trim section further includes a first filler that is disposed between the first trim substrate and the first outer covering, and wherein the second trim section further includes a second filler that is disposed between the second trim substrate and the second outer covering.

17. A method for making an interior panel for an aircraft, the method comprising the steps of:
obtaining a support substrate having a substrate surface that is configured to face generally in a first direction;
coupling a first trim section to the support substrate such that the first trim section is disposed adjacent to the substrate surface, wherein the first trim section has a first exposed surface extending to a first edge portion;
coupling a second trim section to the support substrate such that the second trim section is disposed adjacent to the substrate surface, wherein the second trim section has a second exposed surface extending to a second edge portion that is disposed adjacent to the first edge portion, and wherein the first edge portion is offset from the second edge portion in the first direction to define a gap therebetween; and
substantially covering a light source with the first exposed surface, wherein the light source is configured to generate light that passes through the gap and illuminates at least a portion of the second exposed surface.

18. The method of claim 17, wherein coupling the first trim section to the support substrate includes disposing the first exposed surface such that the first exposed surface is spaced apart from the support substrate in the first direction, and wherein coupling the second trim section to the support substrate includes disposing the second exposed surface such that the second exposed surface is spaced apart from the support substrate in the first direction.

19. The method of claim 17, wherein substantially covering the light source with the first exposed surface includes disposing the light source in the first trim section underlying the first exposed surface.

20. The method of claim 17, further comprising the step of disposing a lens one of across and adjacent to the gap.
